(19) United States
(12) Patent Application Publication
(10) Pub. No.: US 2011/0117528 A1
(43) Pub. Date: May 19, 2011

(54) REMOTE PHYSICAL THERAPY APPARATUS

(76) Inventors: Robert J. Marciello, Stewartsville, NJ (US); Stuart Kippelman, Flemington, NJ (US); Michael A. Tepedino, Monroe Township, NJ (US)

(21) Appl. No.: 12/948,196

(22) Filed: Nov. 17, 2010

Related U.S. Application Data
(60) Provisional application No. 61/262,430, filed on Nov. 18, 2009.

(51) Int. Cl. G09B 23/28

(52) U.S. Cl. 434/262

(57) ABSTRACT

This invention discloses methods and apparatus for tracking prescribed movement of body parts. According to the present invention multiple sensors are used to track body part motion. The tracked motion may then be compared to prescribed motion and also be stored for ascertaining compliance with a prescribed therapy regimen.

### RELATED APPLICATIONS

This application is a non-provisional filing of provisional application, U.S. Ser. No. 61/262,430, filed on Nov. 18, 2009.

### FIELD OF USE

The present invention relates to an apparatus and methods for conducting remote physical therapy.

### BACKGROUND

Currently, Physical Therapy includes a process of leading a patient through a series of bodily motions in a pattern, intensity and range of motion beneficial to a condition being experienced by the patient. Typically a trained and licensed Physical Therapist works personally with the patient in immediate proximity to the patient and guides the patient through a set of prescribed exercises.

Such personal attendance by the Physical Therapist (PT) to the patient is meant to both instruct the patient on a proper way to perform an exercise or set of exercises and to insure that the patient is in full compliance with the prescribed motions and number of repetitions. In addition, the PT will often prescribe a regimen of exercises for the patient to perform on a prescribed schedule while the patient is not with the PT.

Problems come about because of inherent limitations on the amount of patients a PT can see. In addition, a patient's compliance with a prescribed exercise regimen can be an issue.

In addition, although physical therapy treatment is generally accepted as efficacious to the patient there is typically little conclusive evidence as to the effectiveness of compliance with a physical therapy regime.

Efficacy of treatment is directly correlated to the patient's ability and willingness to comply with the assigned work. Heretofore, there is currently no common, cost-effective way to monitor patients' compliance or success. Several factors exacerbate the current shortcoming: including a shortage of PT's; a population surge associated with the baby boom is entering retirement age; insurers often respond to the increased burden of this increase in a need to provide physical therapy treatment by rationing care, requiring evidence based medicine, or a combination of the two.

In another aspect, an effort to lower the cost of care, insurers includes the institution of “Pay for Outcomes.” Pay for Outcome is hindered by a lack of evidence based medicine associated with PT. Physical Therapy remains a largely manual process, with less objective-data generated than most other disciplines. Generally, evidence based medicine algorithms are currently difficult to apply.

Consequently there currently exists a socioeconomic phenomenon that includes a reduced supply of providers on a per capita basis; to the increased demand for both service, and improved outcomes, and a mandate to lower the cost of physical therapy to the provider and the insurer. Improved methods and apparatus are needed to address the issues associated with PT.

### SUMMARY

Accordingly, the present invention includes methods and apparatus for providing on location physical therapy treatment. Automated apparatus with sensors track bodily movements and compare bodily movements with prescribed exercises. The automated apparatus may, in various embodiments, additionally track a frequency of such exercises; a number of repetitions during each respective exercise session; a duration of each exercise session; a range of motion of each exercise; and a level of pain associated with various degrees of motion of each exercise.

### DESCRIPTION OF THE DRAWINGS

FIG. 1 illustrates a patient with sensors.

FIG. 2 illustrates a block diagram of components included in the present invention.

FIG. 3 illustrates steps that may be implemented in some embodiments of the present invention.

FIG. 4 illustrates some additional steps that may be implemented in some embodiments of the present invention.

FIG. 5 illustrates a controller that may be used in some embodiments of the present invention.

### DETAILED DESCRIPTION OF THE INVENTION

According to the present invention, an automated apparatus is provided which tracks and records human motion and relates the tracked human motion to a prescribed Physical Therapy regimen. The tracked motion is recorded and can be presented in graphical form to one or more of: the patient, a caregiver, a health care provider, an insurance carrier, researcher, a family member or other designated third person and others designated by the patient and system provider.

Generally, physical therapy actions are correlated with geometric motion of specific body parts. The body parts may include, for example, a limb, a hand or foot, the torso, neck and head. Motion is calculated for one body part in relation to another body part, as opposed to a body part in relation to a physical surrounding. According to the present invention, automated sensors track actual physical motion of a body part in relation to one or more other body parts and compare the tracked physical motion to geometric motion specified by physical therapy.

In order to clarify the detailed description of the invention included in this specification, the following terms will includes the meanings set forth below:

Goniometer: as used herein shall mean a tool used by a Physical Therapist to measure body angles, such as “patient can lift arm 20 degrees above horizontal.” Data is recorded to capture efficacy of treatment.

PT Aids: as used herein shall mean a one or more of a weight, a walkers, a pad or other device specified by a PT to aid a patient in a physical therapy.

Vestibular Training as used herein shall mean a technique used by a Physical Therapist to treat patients suffering from types of dizziness (vertigo).

PT: as used herein shall mean a “Physical Therapist”

Saccades: as used herein shall mean an exercise which involves an eye movement, and in particular may involve an exercise causing an eye to focus. Exercises forcing the patient to focus at certain objects, in a particular order (saccades) are sometimes used in Vestibular Training.

Set-Top-Device, Set-Top-Box: as used herein shall mean a any electronic component that interacts with a television set. Term reflects the days when televisions were called “television sets,” and were large enough to place things upon. Although televisions are now too thin to place devices on, the term is still used.

Accelerometer as used herein shall mean a device that can detect when it is being moved, can detect the vector it is being moved in, and can convert that motion into a data stream usable by a computer program to track motion. Micro-accelerometers are modern accelerometers that have been shrunk down to size typically less than 5×5×1 mm's.

APTA as used herein shall mean American Physical Therapy Association which is a professional association for physical therapists.

Avatar as used herein shall mean a virtual representation of a person.

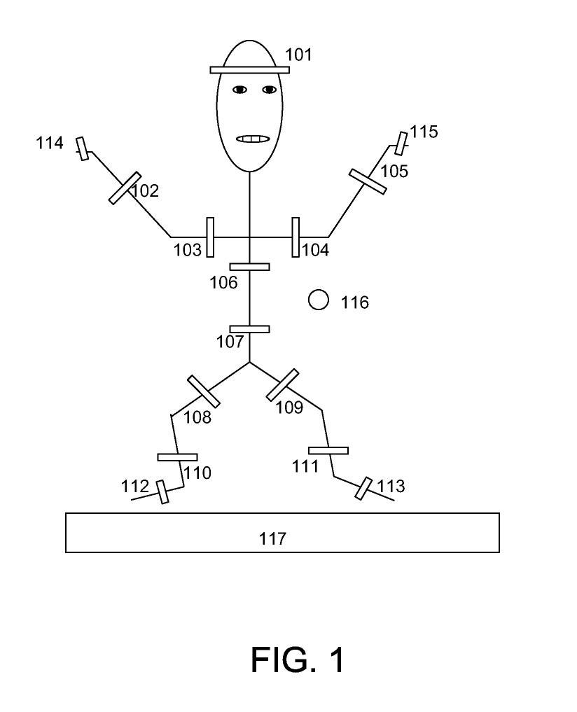

Referring now to FIG. 1, multiple sensors 101-115 are attached to specific points on a body. Two or more sensors 101-113 will work in conjunction with each other to determine a position of a body part such as an arm 102-105, a leg 108-111, an upper torso 106, a lower torso 107, a head 101, a foot 112-113 and a hand 114-115. Preferably the sensors 101-113 will determine a position of a body part in relation to another body part or another sensor, although it is also possible to implement the present invention by tracking the position of a sensor in reference to a fixed point 116.

The sensors 101-113 may include for example micro-electronic machines (MEMs), accelerometers, radio frequency (RF) positioning devices which can determine a position relative to another RF device, or other mechanical and/or semi-conductor device. Relative positions of sensors 101-115 may be determined, for example via one or more of: triangulation of multiple sensors 101-115; tracked motion from a known starting point and reference to a fixed point 116-117. As illustrated a fixed point may be located on the body of the patient 116 or be located on a platform on which the patient stands 117. Other fixed points may also be used.

According to the present invention, two or more sensors 101-115, and preferably three or more sensors 101-115, are operative to determine a location of a body part at a first instance in time and a second instance in time. A processor is used to compare a first location of the body part at the first instance in time to a second location at the second instance in time. Preferably, a succession of instances in time will compare the location of the body part over a continuum of time such that the processor may simulate movement of the body part over the continuum of time.

According to the present invention, such simulated movement is compared with movement involved in a prescribed Physical Therapy regimen. Body part positions may be determined at a given point in time according to the location of associated sensors 101-115. The Physical Therapy regimen may include, by way of non-limiting example: a range of motion of a body part; a rate of motion of a body part; a repetition of motion of a body part within a predetermined time period; a frequency of Physical Therapy exercise sets and a duration of time that Physical Therapy exercise sets will be repeated. A Physical Therapy regimen may address physical injury, stroke, loss of limb control, Vestibular Training, or other proactive or rehabilitative movements. In some embodiments, it may be combined with Saccades in Vestibular Training.

Pain Assessment activity may also be captured in relation to Physical Therapy treatment and tracked with the treatment. For example, it may include asking the patient how to rank their pain on a scale of A to B, where A and B are pre-defined states. Assessments may include icons ranging from a broad smile to a very bad frown, which the Physical Therapist may transpose into a numerical scale. Pain Assessment may be monitored at one or more of: before treatment, during treatment and after a treatment to capture changes in discomfort. According to the present invention, such pain rankings may be input into an automated system and associated with Physical Therapy.

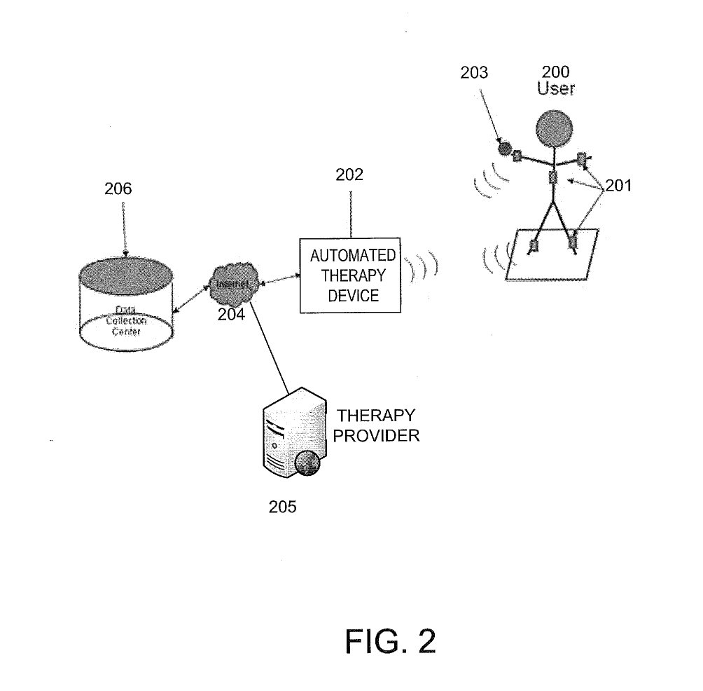

Referring now to FIG. 2, tracked motion is calculated via multiple sensors 201 attached to a user 200 via an automated therapy device 202 generally proximate to the user 200. The automated therapy device 202 may make data collected from the sensors 201 attached to the user 200 available via a distributed network, such as the Internet 204 to other interested parties. Control of the automated therapy device 202 may be accomplished via a control unit 203 available to the user 200.

For example, a data collection center 206 may store an aggregate of data from multiple users 200. In addition, according to the present invention, a network access device 205 is available to a Physical Therapist or other therapy provider. The therapy provider may review actions being taken by the user and provide guidance or adjust the users prescribed exercises according to data made available that is descriptive of movements made by the user.

For example, a therapy provider may instruct a user 200 in one or more of the following ways: increase or decrease a range of motion associated with a therapy regimen; increase or decrease a number of repetitions for a particular exercise; and increase or decrease a frequency of therapy sessions.

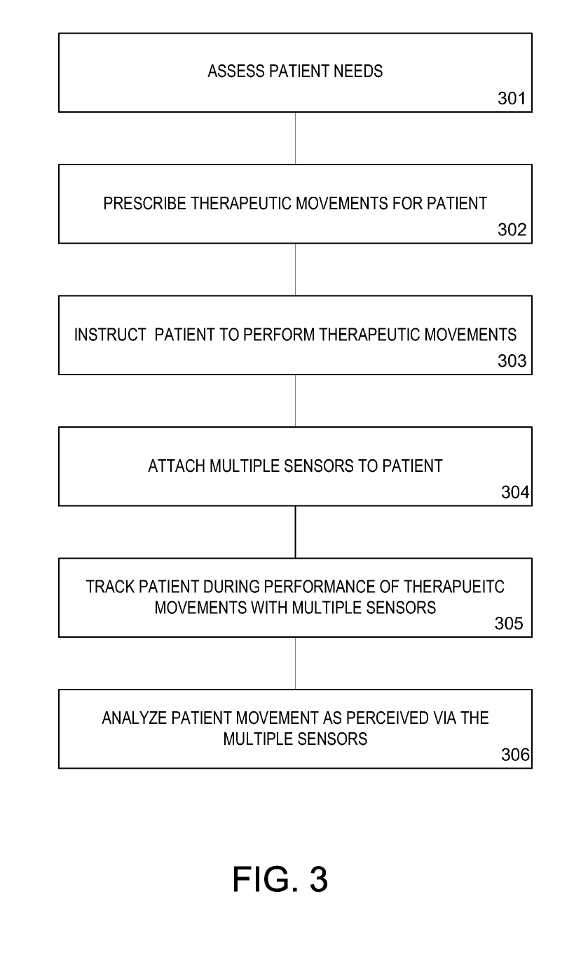

Referring now to FIG. 3, some method steps that may be practiced in some implementations of the present invention are listed in flow chart style. At 301, a patient's needs are assessed. Typically, they will be assessed by a health care provider, such as a physical therapist or a doctor. At 302, therapeutic movements are prescribed for the patient. At 303 the patient is instructed for perform the therapeutic movements. The instruction may take place for example, in a physical therapy facility. The patient may also be instructed on proper use of an automated therapy device.

At 304, multiple sensors are attached to the patient. The sensors will be attached to body parts and in places appropriate to track movements prescribed for the patient. At 305, a patient performs the prescribed movements with multiple sensors attached, such as, for example three or more sensors. Three or more sensors allows for the automated therapy device to triangulate relative positions of the respective sensors.

At 306, the patient movement is analyzed, as that motion is perceived via the multiple sensors. Data associated with the tracked movement is stored for various reference purposes. Reference purposes may include, for example, one or more of: patient compliance with a physical therapy regimen; range of motion, progress on range of motion over a period of time, number of repetitions, strength of a patient and other reference points.

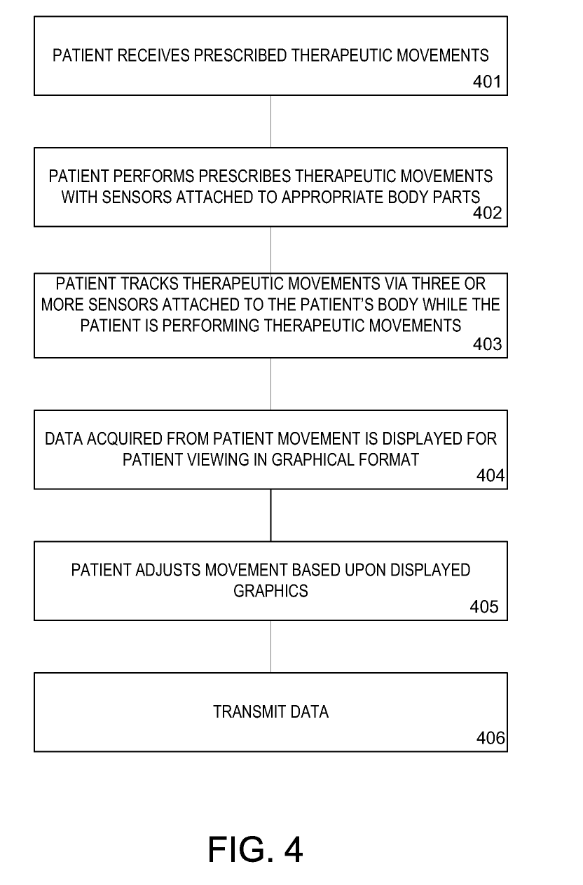

Referring now to FIG. 4, method steps that may be implemented in practicing the present invention from a patient's perspective are presented. At 401, a patient receives prescribed therapeutic movements. The movements will typically be presented to the patient via instruction from a health care professional, however, other methods of instruction, such as via video instruction, or by printed publication may also be used. At 402, the patient performs the prescribed therapeutic movements with sensors attached to appropriate body parts of the patient according to the movement that will be tracked.

At 403, the patient tracks the therapeutic movements via three or more sensors attached to the patient's body while the patient is performing the therapeutic movements. Various embodiments may include the use of a Goniometer as a reference for prescribed movements and the sue of PT aids during performance of prescribed movements.

At 404, a graphical representation of the data captured by the sensors is presented to the patient. In some embodiments, the graphical or video representation includes an avatar of the patient simulating the patient's tracked movement. In addition, in some embodiments an avatar may be shown demonstrating a correct bodily motion. In some embodiments therefore, two avatars may be show, a first avatar indicating actual patient movement and a second avatar indicating a proper movement. In this manner, at 405, a patient may determine if an adjustment to a movement will bring the patient into correct form. A set top device or other graphical controller may be used in some embodiments to present the graphical presentation.

At 406, data may also be transmitted which enables a graphical image of the user to be presented at a remote location. For example, an avatar may indicate to a health care provider whether a patient is properly performing the prescribed exercises.

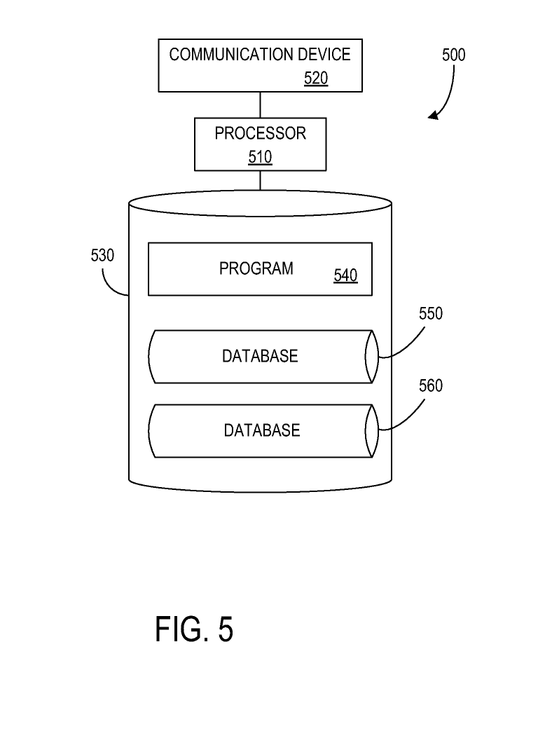

Referring now to FIG. 5, FIG. 5 illustrates a controller 500 that may be used to implement some aspects of the present invention. A processor unit 510, which may include one or more processors, coupled to a communication device 520 configured to communicate via a communication network. The processor 510 is also in communication with a storage device 530. The storage device 530 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 530 can store executable software programs 515 for controlling the processor 510. The processor 510 performs instructions of the program 515, and thereby operates in accordance with the present invention. The storage device 530 can store related data in a database.

### CONCLUSION

The present invention, as described above and as further defined by the claims below, provides methods of processing capturing prescribed movements, storing data associated with such movements and transmitting at least some of such data.

1. A computerized apparatus for automated patient physical therapy, the apparatus comprising:
a computer server accessible with a network access device via a communications network; and
executable software stored on the server and executable on demand, the software operative with the server to cause the apparatus to:
prescribe at least one therapeutic movement for a patient;
instruct the patient on performance of the at least one therapeutic movement;
receive input from multiple sensors attached to the patient;
track a relative position of the multiple sensors during performance of the at least one therapeutic movement, said tracking based upon the input received from the multiple sensors; and
displaying in a human recognizable form a virtual simulation of the therapeutic movement based upon the tracking of the relative position of the multiple sensors during the performance of the at least one therapeutic movement.

2. The apparatus of claim 1 wherein the software is additionally operative to assess a physical therapy need for a patient.

3. The apparatus of claim 1 wherein the instruction of therapeutic movement comprises instruction from a physical therapist.

4. The apparatus of claim 1 wherein the instruction of therapeutic movement comprises instruction from a video segment.

5. The apparatus of claim 1 wherein virtually simulating therapeutic movement comprises instruction from a video segment.

6. The apparatus of claim 1 wherein the tracking of the relative position of the multiple sensors during the performance of the at least one therapeutic movement comprises triangulation of the position of three or more sensors attached to the patient.

7. The apparatus of claim 6 tracking of the relative position of the multiple sensors during the performance of the at least one therapeutic movement additionally comprises triangulation with at least one fixed point.

8. The apparatus of claim 7 wherein the fixed point comprises a platform on which the patient stands.

9. The apparatus of claim 7, wherein the fixed point is based upon a transmitting sensor fixed to the patient.

10. The apparatus of claim 1 wherein the software is additionally operative to transmit data to a remote network access device.

11. The apparatus of claim 10 wherein the remote network access device is associated with a health care provider caring for the patient.

12. The apparatus of claim 10 wherein the remote network access device is associated with an insurance provider insuring the patient.

13. The apparatus of claim 11 wherein the remote network access device comprises a data storage device archiving data related to the patient's therapy.

14. The apparatus of claim 1 additionally comprising displaying a virtual image based upon the tracked movements of the patient.

15. The apparatus of claim 14 wherein the software is additionally operative to modifying a therapeutic movement based upon the displaying of a virtual image based upon the tracked movements of the patient.
